(19) United States
(12) Patent Application Publication
(10) Pub. No.: US 2012/0054353 A1
(43) Pub. Date: Mar. 1, 2012

(54) WLAN TERMINAL SUPPORTING MOBILE INFRASTRUCTURE MODE AND METHOD OF PROVIDING TETHERING SERVICE OF THE SAME

(75) Inventors: Bu Seop JUNG, Suwon-si (KR); Jung Hun LEE, Suwon-si (KR)

(73) Assignee: SAMSUNG ELECTRONICS CO. LTD., Suwon-si (KR)

(21) Appl. No.: 13/218,834

(22) Filed: Aug. 26, 2011

(30) Foreign Application Priority Data
Aug. 26, 2010 (KR) 10-2010-0082739

(51) Int. Cl. G06F 15/16

(52) U.S. Cl. 709/227

(57) ABSTRACT

A Wireless Local Area Network (WLAN) terminal and tethering service providing method for the same are provided. The WLAN terminal supporting a mobile infrastructure mode effectively provides a tethering service to external devices by managing external devices using an operating device list and a waiting device list. The method includes: receiving a connection request from a device, determining whether an operating device list is full, adding the device to the operating device list when the operating device list is not full, providing a tethering service to the device, determining whether a waiting device list is full when the operating device list is full, adding the device to the waiting device list when the waiting device list is not full, and permitting connection of the device and preventing the device from receiving a tethering service, and rejecting the connection request when the waiting device list is full.

### PRIORITY

This application claims the benefit under 35 U.S.C. §119(a) of a Korean patent application filed on Aug. 26, 2010 in the Korean Intellectual Property Office and assigned Serial No. 10-2010-0082739, the entire disclosure of which is hereby incorporated by reference.

### BACKGROUND OF THE INVENTION

1. Field of the Invention

The present invention relates to a method for providing a tethering service and an apparatus for the same. More particularly, the present invention relates to a Wireless Local Area Network (WLAN) terminal supporting a mobile infrastructure mode and a tethering service providing method of the same that effectively provide a tethering service to external devices by managing external devices using an operating device list and a waiting device list.

2. Description of the Related Art

With the increasing number of devices that can access the Internet via Wireless Local Area Networks (WLANs), Wireless-Fidelity (Wi-Fi) tethering has attracted considerable attention. Wi-Fi tethering refers to a feature in which a mobile terminal capable of accessing both a cellular network and a WLAN, or in other words a WLAN terminal, acts as an agent that enables a Wi-Fi device that is incapable of accessing a cellular network to access the Internet through the cellular network accessed by the mobile terminal.

When a WLAN includes an Access Point (AP), it is described as operating in an infrastructure mode or as being an infrastructure network. A mobile infrastructure mode refers to a WLAN operating in the infrastructure mode where a mobile terminal acts as the AP.

A connection, through a cellular network such as Universal Mobile Telecommunication System (UMTS) or General Packet Radio Service (GPRS), used in tethering may provide a limited data rate, such as 7.2 Mbps. When multiple devices share such a cellular network connection for tethering, each device may experience unsatisfactory throughput owing to data rate limitations due to sharing the limited data rate. This is because recently developed mobile terminals supporting mobile infrastructure mode have a limit on a maximum number of devices sharing a cellular network connection.

Unlike an infrastructure mode AP, only a small number of devices are normally allowed to join a Basic Service Set (BSS) formed by a WLAN terminal supporting the mobile infrastructure mode. While the BSS formed by an AP in a hotspot is rarely changed after initiation of operation of the mobile infrastructure mode, the BSS formed by a WLAN terminal supporting the mobile infrastructure mode may be dynamically changed. In addition, as only a small number of devices are allowed to perform tethering, the WLAN terminal needs to dynamically control a connection and a disconnection of a particular device.

For example, when the maximum number of connectable devices has already been reached, the WLAN terminal may wish to disconnect an existing Wi-Fi connection with one device and allow another device to join the Wi-Fi network. However, the WLAN terminal operating in mobile infrastructure mode may have great difficulty in disconnecting the one device having the existing Wi-Fi connection unless the one device voluntarily disconnects the Wi-Fi connection. That is, the WLAN terminal operating in the mobile infrastructure mode may be incapable of disconnecting a tethered device.

More specifically, a Wi-Fi device such as a laptop computer and a mobile terminal activates an automatic connection function by default. Even when an AP, which is an AP in the infrastructure mode or a WLAN terminal operating in mobile infrastructure mode, disconnects the Wi-Fi connection to a particular device by sending a deassociation frame, the device automatically attempts to access the AP using a list of recently accessed APs. As a Service Set Identifier (SSID) and a security key of the AP do not change, the device will succeed in connecting to the AP without difficulty.

More particularly, in the event where no other AP is present in a vicinity of the AP, disconnecting and re-connecting of a device may be repeated. When the maximum number of connectable devices is reached, a WLAN terminal operating in the mobile infrastructure mode may fail to secure sufficient time to disconnect an existing Wi-Fi connection with a first device and establish a new Wi-Fi connection with a second device because the first device rapidly and repeatedly attempts to connect to the WLAN terminal This may significantly decrease usability of the WLAN terminal supporting the mobile infrastructure mode.

The above problem may become serious in tethering services. In tethering, users pay to access a cellular network such as a UMTS network. The user of the WLAN terminal supporting the mobile infrastructure mode may wish to disconnect an existing Wi-Fi connection leading to a particular device so as not to pay for access to the cellular network for the device. However, automatic re-connection of the device to the WLAN terminal may frustrate the intention of the user, decreasing usability of the WLAN terminal supporting mobile infrastructure mode.

Media Access Control (MAC) filtering may be utilized to prevent a particular device from accessing the AP. That is, when the AP disconnects the device, it may reject access requests from the device through MAC address filtering. Later, allowing the device to access the AP entails an inconvenience of changing MAC address settings. Alternatively, in order to not pay for a tethered device to access the cellular network, the device may be forced to disconnect from the WLAN terminal supporting mobile infrastructure mode. In this case, later, to provide a tethering service to the device, a Wi-Fi connection between the device and the WLAN terminal should be set up.

### SUMMARY OF THE INVENTION

Aspects of the present invention are to address at least the above problems and/or to provide at least the advantages described below. Accordingly, an aspect of the present invention is to provide an effective tethering service method in a Wireless Local Area Network (WLAN) terminal supporting a mobile infrastructure mode.

Another aspect of the present invention is to provide a WLAN terminal supporting the mobile infrastructure mode and a tethering service providing method of the same that increase usability of a tethering service by managing external devices wishing to access the WLAN terminal using an operating device list and a waiting device list.

Another aspect of the present invention is to provide an environment that enables adaptive disconnection of an existing link leading to an external device during a tethering service using an operating device list and a waiting device list.

Another aspect of the present invention is to provide a tethering service environment that enhances user convenience and usability in tethering based on a WLAN terminal supporting the mobile infrastructure mode.

In accordance with an exemplary embodiment of the present invention, a method of providing a tethering service is provided. The method includes receiving a connection request from an external device, determining whether an operating device list is full, adding the external device to the operating device list when the operating device list is not full, providing a tethering service to the external device, determining whether a waiting device list is full when the operating device list is full; adding the external device to the waiting device list when the waiting device list is not full, permitting connection of the external device and preventing the external device from receiving a tethering service, and rejecting the connection request from the external device when the waiting device list is full.

In accordance with another exemplary embodiment of the present invention, a computer readable storage medium that stores a computer program implementing the above method is provided.

In accordance with another exemplary embodiment of the present invention, a WLAN terminal supporting a tethering service is provided. The WLAN terminal includes a WLAN module for performing data transmission and reception to and from an external device through a Wireless-Fidelity (Wi-Fi) connection, a communication module for performing data transmission and reception for the WLAN terminal and the external device connected with the WLAN module, a display unit for displaying an operating device list and a waiting device list in list view mode, and a control unit for determining the operating device list and the waiting device list upon reception of a connection request from an external device, and for controlling an operation to support tethering when the external device is added to the operating device list in order to allow connection setup when the external device is added to the waiting device list, or to reject the connection request.

Hereinabove, the features and advantages of the present invention are described in a relatively broad perspective to help those skilled in the art understand the present invention. Other features and advantages constituting the subject matter of the present invention will be more apparent from the following detailed description.

In a feature of the present invention, the tethering service providing method enables a WLAN terminal supporting a mobile infrastructure mode to adaptively manage external devices connected or attempting to connect to the WLAN terminal. The devices attempting to connect to the WLAN terminal are managed using an operating device list and a waiting device list. The devices on the waiting device list are allowed to connect to the WLAN terminal but packets transmitted by the devices are subjected to packet filtering. Hence, although a number of external devices to be operated by a user exceeds a size of the operating device list, when it does not exceed a sum of the sizes of the operating device list and the waiting device list, the WLAN terminal may manage all the external devices and provide a tethering service to selected devices.

Accordingly, the WLAN terminal does not have to repeat a disconnection and a reconnection of external devices and may prevent delay due to the reconnection. In particular, when it is necessary to significantly increase throughput of a specific tethered device, the WLAN terminal may move the remaining devices on the operating device list to the waiting device list.

In addition, automatic reconnection attempts made by a disconnected device may be handled more effectively. That is, when the user disconnects a device from the WLAN terminal, the WLAN terminal records a Media Access Control (MAC) address of the device and, later, when the device is connected, automatically adds the device to the waiting device list. Hence, additional charges for tethering may be avoided. A device on the waiting device list may be moved to the operating device list and then use the tethering service.

Exemplary embodiments of the present invention may realize an effective tethering service in a WLAN terminal supporting mobile infrastructure mode, thereby contributing to enhancing usability, convenience and competitiveness of the WLAN terminal

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description in conjunction with the accompanying drawings, in which:

FIG. 1 illustrates a system configuration for providing a tethering service according to an exemplary embodiment of the present invention;

FIG. 2 is a block diagram of a Wireless Local Area Network (WLAN) terminal according to an exemplary embodiment of the present invention;

FIGS. 3 and 4 are flowcharts of a tethering service providing method according to another exemplary embodiment of the present invention; and

FIGS. 5 and 6 illustrate operations to manage external devices attempting to connect to the WLAN terminal for tethering according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces

Exemplary embodiments of the present invention relate to a tethering service providing method of a Wireless Local Area Network (WLAN) terminal or a Wireless-Fidelity (Wi-Fi) terminal supporting a mobile infrastructure mode. According to an exemplary embodiment, external devices, such as a notebook, a netbook, a Personal Digital Assistant (PDA), a Personal Computer (PC), a portable gaming console, or other similar electronic devices wishing to connect to the WLAN terminal are managed using an operating device list and a waiting device list for more effective tethering.

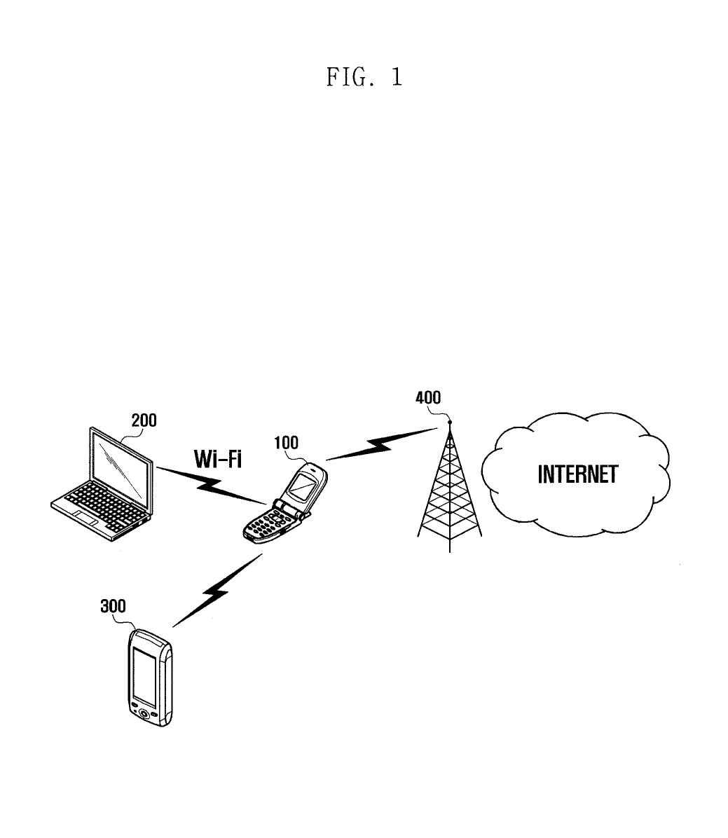

FIG. 1 illustrates a system configuration for providing a tethering service according to an exemplary embodiment of the present invention.

Referring to FIG. 1, the system for tethering, identified by a Basic Service Set (BSS), includes WLAN terminals 100, 200 and 300 and a cellular network 400. In particular, the WLAN terminals 100, 200 and 300 are classified into a WLAN terminal 100 supporting a mobile infrastructure mode and external devices 200 and 300 connecting to the WLAN terminal 100 for tethering. The WLAN terminal 100 and the devices 200 and 300 are Wi-Fi capable devices.

The WLAN terminal 100 is a terminal that is capable of connecting to the cellular network 400 and supports WLAN functions. More particularly, the WLAN terminal 100 may operate in the mobile infrastructure mode and supports tethering for external devices including the devices 200 and 300 using an operating device list and a waiting device list.

Each of the devices 200 and 300 is a Wi-Fi or WLAN device that is incapable of directly connecting to the cellular network 400 and is capable of accessing the Internet over the cellular network 400 via the WLAN terminal 100. The cellular network 400 provides mobile communication services and Internet services to mobile terminals including the WLAN terminal 100 within a coverage range of the cellular network 400.

As described in FIG. 1, a tethering service may be provided using the WLAN terminal 100 as an agent. The devices 200 and 300, which are incapable of connecting to the cellular network 400, may connect to the WLAN terminal 100 and access the Internet over the cellular network 400 via the WLAN terminal 100. In other words, the WLAN terminal 100 may act as a mobile Access Point (AP).

In tethering, the WLAN terminal 100 is used as a modem, and information technology devices or electronic devices such as a laptop, a netbook, a tablet, a desktop computer, an ebook reader, a Personal Digital Assistant (PDA), a portable gaming console, or other similar electronic devices, including the devices 200 and 300, may connect to the WLAN terminal 100 and access the Internet. That is, in tethering, the devices 200 and 300 may wirelessly access the Internet by connecting to the WLAN terminal 100 which acts as a wireless modem through Wi-Fi.

Generally, wireless Internet access may be achieved through a cellular network, such as a 3^{rd} Generation (3G) mobile communications network, a high-speed portable Internet service network, such as Wireless Broadband (WiBro) or a WLAN. For wireless Internet access, tethering employs a cellular network. Compared with using a WiBro service or a WLAN, although tethering based on a cellular network may be slower and more expensive and may consume more power, it enables Internet access at any location within a cellular network coverage range. More particularly, in a region where no direct Internet connection is available, tethering is useful for enabling a laptop or a netbook to transfer data or to access the Internet via a WLAN terminal.

An operating device list is a list of external devices that are connected through a Wi-FI connection to the WLAN terminal 100 and which currently receive a tethering service. A waiting device list is a list of external devices that are connected through a Wi-FI connection to the WLAN terminal 100 but which are not allowed to receive a tethering service.

In the present exemplary embodiment, the WLAN terminal 100 supporting the mobile infrastructure mode provides different services to the devices on the operating device list than services provided to the devices on the waiting device list. For example, packet filtering is applied to the devices on the waiting device list and they are not allowed to receive an Internet service through tethering. Hence, use of the waiting device list enables the AP to disconnect a specific device, solving the disconnection problem described before. Accordingly, the user of the WLAN terminal 100 supporting the mobile infrastructure mode may manage external devices connected to the WLAN terminal 100 in a more adaptive manner.

The WLAN terminal 100, or in other words, the AP, using the waiting device list may accommodate a larger number of external devices compared to an existing or conventional WLAN terminal or AP. That is, the conventional WLAN terminal supporting the mobile infrastructure mode normally has a limit to a number of tethered devices in consideration of data rates. When the number of tethered devices reaches the limit, additional devices in excess of the limit number are not connected to the existing terminal In the present exemplary embodiment, after the number of tethered devices reaches the limit, the WLAN terminal 100 may add an additional device to the waiting device list. The WLAN terminal 100 applies packet filtering to a device on the waiting device list so that the device may not perform data transmission and reception above the Media Access Control (MAC) layer. That is, a device on the waiting device list is connected to the WLAN terminal 100 through a Wi-Fi connection but is prevented from receiving a tethering service. The difference between the waiting device list and the operating device list is described below.

The WLAN terminal 100 supporting the mobile infrastructure mode applies packet filtering to a device on the waiting device list so as to prevent the device from transmitting and receiving data frames above the MAC layer. That is, when a device on the waiting device list requests a tethering service, the WLAN terminal 100 ignores the request. When the user of the WLAN terminal 100 moves a device on the waiting device list to the operating device list, packet filtering is not applied to the moved device. In reverse, when the user of the WLAN terminal 100 moves a device on the operating device list to the waiting device list, packet filtering is applied to the moved device. The sizes of the operating device list and the waiting device list may be set differently according to a performance of the WLAN terminal 100.

Next, a description is given of utilization of the waiting device list.

When a connection request is received from the device 200, which is also referred to as a requesting device 200, satisfying preset conditions, such as a Service Set Identifier (SSID) and a security key requirement, the WLAN terminal 100 supporting the mobile infrastructure mode determines whether the number of devices on the operating device list has reached a preset limit, which indicates that the operating device list is full.

When the operating device list is not full, the WLAN terminal 100 examines whether the requesting device 200 is a device disconnected by the user by checking a MAC address of the requesting device 200. To achieve this, a disconnection list may be used to record MAC addresses of disconnected devices. When the requesting device 200 is a disconnected device, the WLAN terminal 100 determines whether the number of devices on the waiting device list has reached the preset limit. When the requesting device 200 is not a disconnected device, the WLAN terminal 100 may add the requesting device 200 to the operating device list and permits the requesting device 200 to receive a tethering service.

When the operating device list is full, the WLAN terminal 100 determines whether the waiting device list is full. When the waiting device list is full, the WLAN terminal 100 may reject the connection request of the requesting device 200. When the waiting device list is not full, the WLAN terminal 100 may add the requesting device 200 to the waiting device list and then apply packet filtering to the requesting device 200.

While providing AP services such as the tethering service to devices on the operating device list, when the user of the WLAN terminal 100 makes a request to disconnect a connected one of the device 300 on the operating device list, the WLAN terminal 100 disconnects the device 300 by adding the MAC address of the device 300 to the disconnection list and sending a deassociation frame to the device 300.

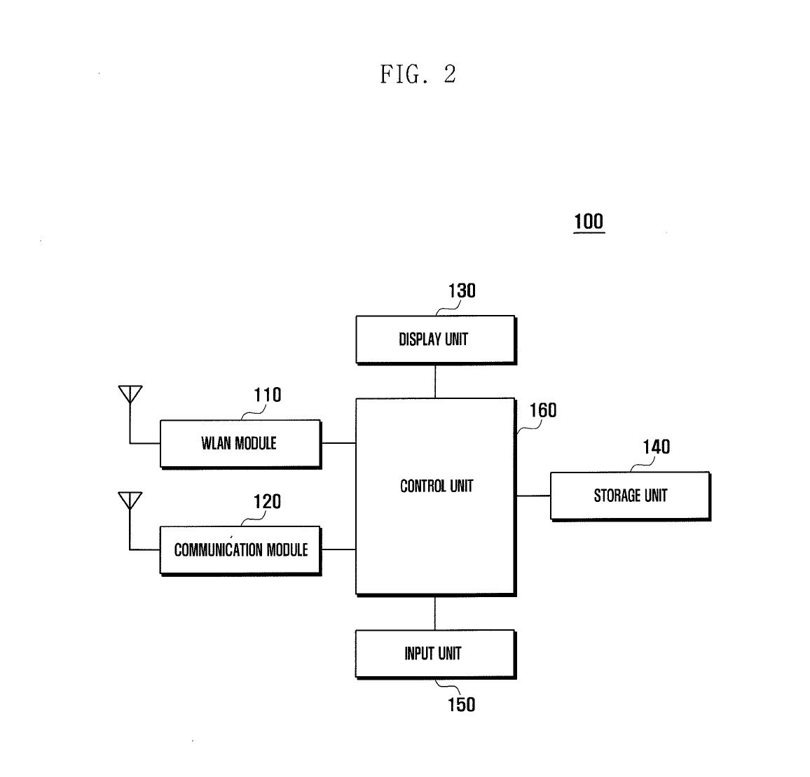

FIG. 2 is a block diagram of a WLAN terminal according to an exemplary embodiment of the present invention.

Referring to FIG. 2, the WLAN terminal 100 includes a WLAN module 110, a communication module 120, a display unit 130, a storage unit 140, an input unit 150, and a control unit 160. Although not shown, the WLAN terminal 100 may further include various components, such as an audio processing unit including a microphone and a speaker, a digital broadcast receiving module for Digital Multimedia Broadcasting (DMB) or Digital Video Broadcasting (DVB), a camera module for taking still and moving images, a Bluetooth module for Bluetooth communication and a touchscreen or touchpad for touch-based input. These additional components will not be described further.

The WLAN module 110 supports Internet access of the WLAN terminal 100. The WLAN module 110 supports Wi-Fi based communication between the WLAN terminal 100 and another WLAN terminal such as a device 200 or 300.

The communication module 120 includes a radio frequency chip (not shown) for radio frequency communication and the communication module 120 may connect to the cellular network 400 to receive communication services for the WLAN terminal 100. The communication module 120 may perform data transmission and reception for external devices such as devices 200 and 300 which are tethered to the WLAN terminal 100. For example, in tethering, the communication module 120 may handle data transmission and reception for external devices connected through the WLAN module 110.

The display unit 130 outputs execution screens associated with applications run by the WLAN terminal 100. For example, execution screens may be associated with functions related to messages, email, Internet access, a multimedia, search, communication, ebooks, a capture of still and moving images, a playback of still and moving images, mobile Television (TV) such as Digital Multimedia Broadcasting (DMB) and Digital Video Broadcasting (DVB), music or Moving Pictures Expert Group-1 (MPEG-1) Audio Layer 3 (MP3) playback, widgets, memos and games, or other similar functions. The display unit 130 may be realized using Liquid Crystal Display (LCD) elements, Organic Light Emitting Diodes (OLEDs) or Active Matrix OLEDs (AMOLEDs). The display unit 130 may display an application screen in a landscape mode or a portrait mode according to an orientation of the WLAN terminal 100. The display unit 130 may have a touchscreen capability. That is, the display unit 130 may generate an input signal corresponding to a touch gesture made by the user and send the input signal to the control unit 160.

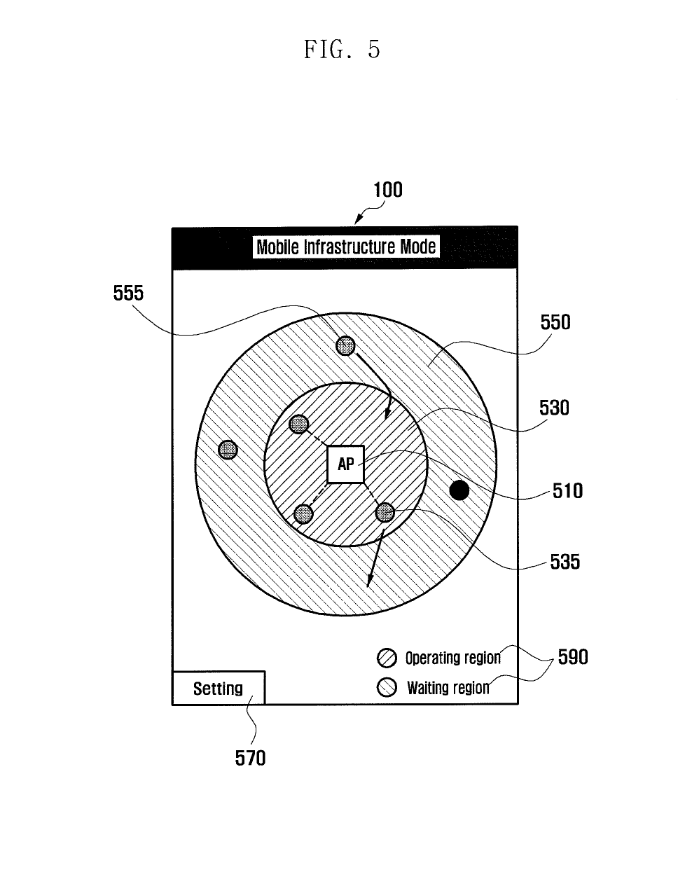

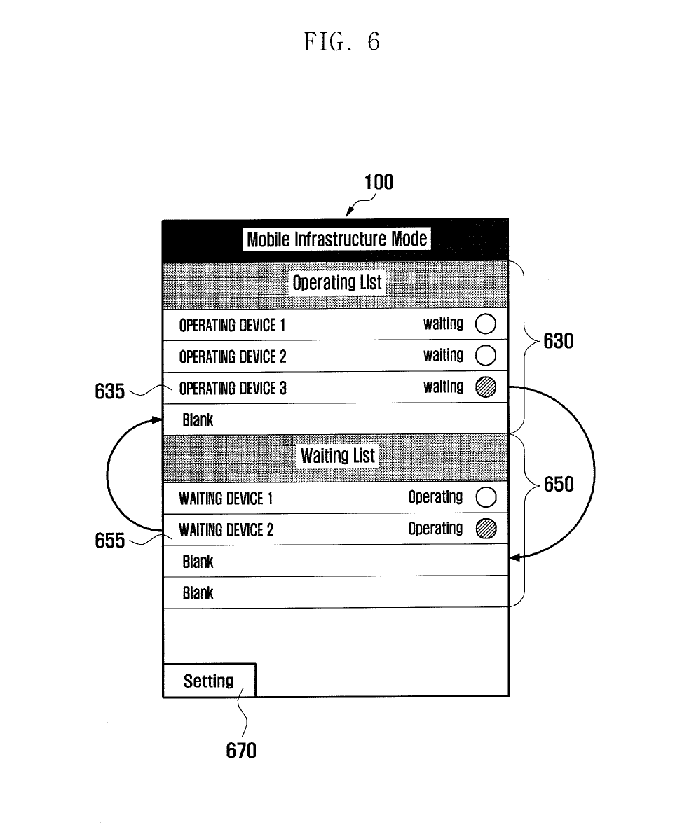

In particular, the display unit 130 may display a list screen related to the operating device list or the waiting device list. Here, the list screen may be displayed in a graphic view mode or a list view mode according to a user's selection or settings. Example list screens are shown in FIGS. 5 and 6.

The storage unit 140 stores various programs executed and data processed by the WLAN terminal 100, and may include one or more volatile and non-volatile memories. For example, the storage unit 140 may temporarily or semi-permanently store any of the following: an operating system of the WLAN terminal 100, a program and data for controlling display operations of the display unit 130, a program and data for controlling input operations using the display unit 130, a program and data for controlling input operations of the input unit 150, a program and data for handling the operating device list and the waiting device list in tethering, a program and data for applying packet filtering in tethering, and a program and data for handling device movement between the operating device list and the waiting device list in a graphic view mode or a list view mode. In particular, the storage unit 140 stores the operating device list, the waiting device list and the disconnection list and stores information regarding devices, such as MAC addresses, or other similar device information, on the lists.

The input unit 150 generates an input signal corresponding to user manipulation and/or user input and sends the input signal to the control unit 160. The input unit 150 may include a plurality of function keys. The input unit 150 includes at least one of a 3×4 keypad, a 4×3 keypad, a qwerty keypad and a touchpad, or other suitable input devices, as an input means. In particular, the input unit 150 includes a function key for controlling device movement between the operating device list and the waiting device list. The input unit 150 may generate an input signal corresponding to a user action on the input means and function keys, and send the generated input signal to the control unit 160.

The control unit 160 controls an overall operation of the WLAN terminal 100. In particular, the control unit 160 may control operations related to tethering. When a tethering request is received from an external device, the control unit 160 checks the operating device list and the waiting device list and determines whether to accept or reject the tethering request. That is, on the basis of the operating device list and the waiting device list, the control unit 160 may permit the device to receive the requested tethering service, may permit the device to connect to the WLAN terminal 100, or may reject the tethering request. When the user makes a request for disconnecting a device that is currently on the operating device list or the waiting device list, the control unit 160 may add the device to the disconnection list for further control.

For example, when a connection request is received from an external device, the control unit 160 determines whether the operating device list is full. When the operating device list is not full, the control unit 160 may add the device to the operating device list and control data transmission and reception so as to provide a tethering service to the device. When the operating device list is full, the control unit 160 may determine whether the waiting device list is full. When the waiting device list is full, the control unit 160 may reject the connection request. When the waiting device list is not full, the control unit 160 may add the device to the waiting device list so as to allow the device to connect to the WLAN terminal 100 and apply packet filtering to the device in order to prevent the device from receiving a tethering service.

In the list view mode, the control unit 160 may control the device movement between an operating region and a waiting region on the display unit 130, and may add or delete a particular device to and from the operating device list and the waiting device list according to the device movement. For example, to move a device in the operating region to the waiting region, the control unit 160 may check whether the waiting device list is full, and when the waiting device list is not full, move the device from the operating device list to the waiting device list. The control unit 160 may also control the display unit 130 to display the moved device in the waiting region. To move a device in the waiting region to the operating region, the control unit 160 may check whether the operating device list is full, and when the operating device list is not full, move the device from the waiting device list to the operating device list. Also, the control unit 160 may control the display unit 130 to display the moved device in the operating region.

Operations of the control unit 160 are described later in more detail with reference to the operation of the WLAN terminal 100 for tethering.

In addition, the control unit 160 controls normal operations of the WLAN terminal 100. For example, when an application is executed, the control unit 160 may control execution and data display of the application. The control unit 160 may perform or control an operation according to an input signal received from the display unit 130 and the input unit 150.

The WLAN terminal 100 may be one of a bar type, a folder type, a slide type, a swing type, a flip type or any other suitable type of a WLAN terminal. The WLAN terminal 100 may be any form of information and communication appliance, such as a mobile communication terminal supporting a particular communication protocol for a communication system, or a smart phone, or any other type of suitable information and communication appliance or electrical device.

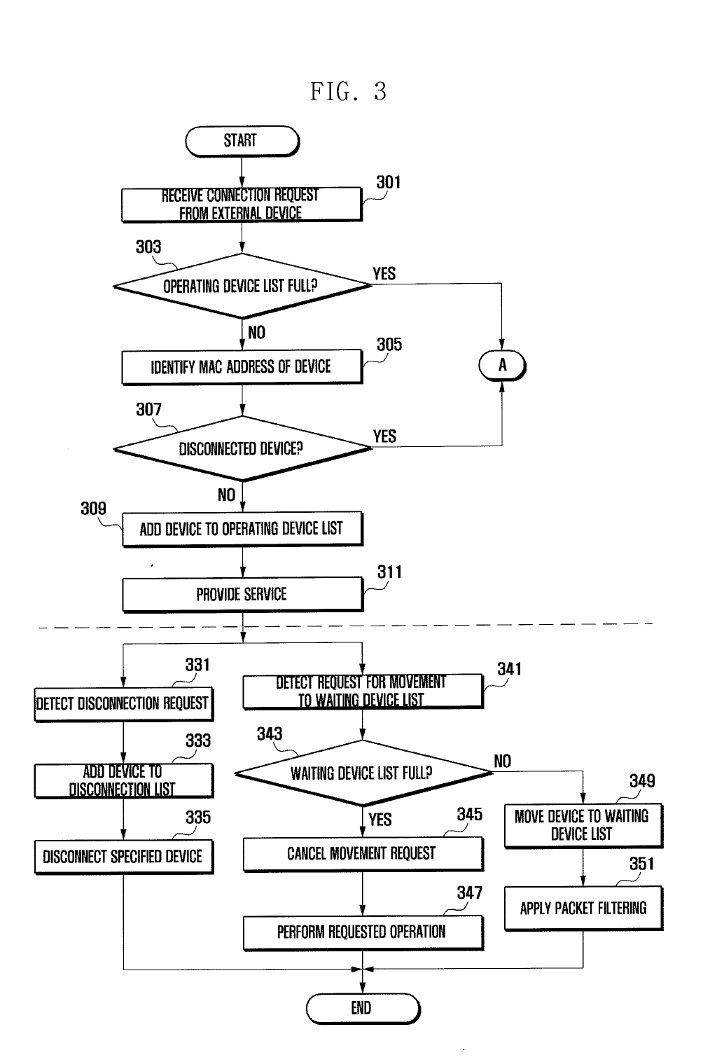

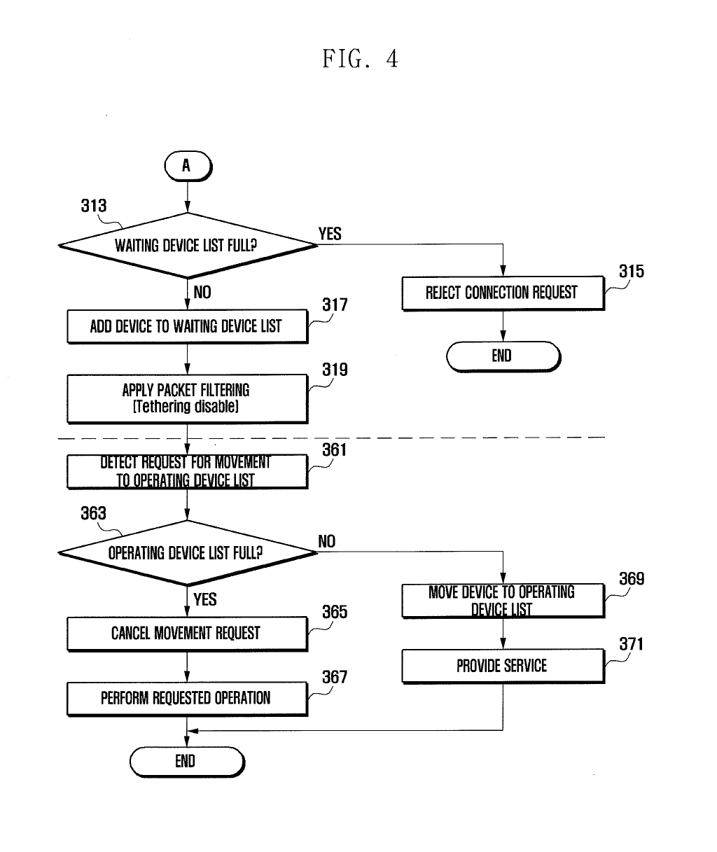

FIGS. 3 and 4 are flowcharts of a tethering service providing method according to another exemplary embodiment of the present invention.

Referring to FIGS. 3 and 4, the control unit 160 of the WLAN terminal 100 may receive a connection request for tethering from an external device in step 301. For example, with reference to FIG. 1, an external device 200 wishing to access the Internet via the WLAN terminal 100 may send the connection request for tethering to the WLAN terminal 100 through a Wi-Fi connection. Here, the device 200 may send the MAC address of the device 200 to the WLAN terminal 100 when sending the connection request or Wi-Fi connection setup. The WLAN terminal 100 may receive the connection request through the WLAN module 110.

Upon reception of the connection request for tethering, the control unit 160 determines whether the operating device list is full in step 303. Thus, in step 303, the control unit 160 may compare a number of devices currently on the operating device list with a maximum number of entries allowed on the operating device list.

When the operating device list is not full, the control unit 160 identifies the MAC address of the device in step 305 and determines whether the device is a disconnected device in step 307. Here, the control unit 160 may determine whether the MAC address of the requesting device is on the disconnection list, and determine the requesting device to be a disconnected device when the MAC address is on the disconnection list.

When the device is not a disconnected device, the control unit 160 adds the device to the operating device list in step 309 and provides a requested service to the device in step 311. The control unit 160 may control the communication module 120 in order to connect to the cellular network 400 and support Internet access of the device. That is, the control unit 160 supports a tethering service for the device.

When the operating device list is full, the control unit 160 determines whether the waiting device list is full in step 313. Here, the control unit 160 may compare a number of devices currently on the waiting device list with maximum number of entries allowed on the waiting device list.

When the waiting device list is full, the control unit 160 rejects the connection request of the device in step 315.

When the waiting device list is not full, the control unit 160 adds the device to the waiting device list in step 317 and applies packet filtering to the device using the MAC address of the device in step 319. The control unit 160 applies packet filtering to a device on the waiting device list so as to prevent the device from receiving a tethering service while providing a tethering service to a device on the operating device list. That is, a device on the waiting device list is allowed to connect to the WLAN terminal 100 through a Wi-Fi connection but is but is not allowed to receive the tethering service. When a device on the waiting device list requests a tethering service, the control unit 160 ignores the request.

As described above in connection with steps 301 to 311, when a connection request is received from an external device satisfying preset conditions such as a SSID and a security key requirement, the control unit 160 of the WLAN terminal 100 supporting the mobile infrastructure mode determines whether the operating device list is full. The SSID is an identifier that is unique to a terminal forming a WLAN. An external device not knowing the SSID of the WLAN terminal supporting the mobile infrastructure mode cannot access the WLAN terminal without the SSID.

When the operating device list is not full, the control unit 160 examines whether the requesting device is a device disconnected by the user by checking the MAC address of the device. When the requesting device is a disconnected device listed on the disconnection list, the control unit 160 determines whether the waiting device list is full. When the requesting device is not a disconnected device, the control unit 160 adds the requesting device to the operating device list and provides a requested service to the device.

When the operating device list is full, the control unit 160 determines whether the waiting device list is full. When the waiting device list is full, the control unit 160 rejects the connection request of the device. When the waiting device list is not full, the control unit 160 adds the device to the waiting device list and then applies packet filtering to the device using the MAC address thereof.

After step 311, the control unit 160 may disconnect a device according to a user request, as shown in steps 331 to 335 of FIG. 3. After step 311, the control unit 160 may move a device on the operating device list to the waiting device list according to a user request, as shown in steps 341 to 351 of FIG. 3. After step 319, the control unit 160 may move a device on the waiting device list to the operating device list according to a user request, as shown in steps 361 to 371 of FIG. 4. Disconnection of a specific device and device movement between the operating device list and the waiting device list may be flexibly performed by the user using an interface screen shown in FIG. 5 or 6. Hereinafter, a description is given of device disconnection and device movement between the lists.

Next, device disconnection is described with reference to steps 331 to 335 shown in FIG. 3.

Referring to FIGS. 3 and 4, while providing services such as the tethering service to one or more devices on the operating device list, the control unit 160 may detect a disconnection request for a specific device on the operating device list from the user in step 331. For example, the user of the WLAN terminal 100 supporting the mobile infrastructure mode may enter a disconnection request for a specific device on the operating device list through the display unit 130 or the input unit 150. The display unit 130 or the input unit 150 transfers the disconnection request to the control unit 160.

Upon detection of the disconnection request for the specific device, the control unit 160 adds the specific device to the disconnection list in step 333 and disconnects the specific device in step 335. For example, the control unit 160 may add the MAC address of the specific device to the disconnection list and send a deassociation frame to the device. The control unit 160 may delete the specific device from the operating device list.

Next, a device movement from the operating device list to the waiting device list is described with reference to steps 341 to 349 of FIG. 3.

Referring to FIGS. 3 and 4, while providing services such as the tethering service to one or more devices on the operating device list, the control unit 160 may detect a user request to move a specific device on the operating device list to the waiting device list in step 341. For example, the user of the WLAN terminal 100 supporting the mobile infrastructure mode may enter a movement request for a specific device from the operating device list to the waiting device list through the display unit 130 or the input unit 150. The display unit 130 or the input unit 150 transfers the movement request to the control unit 160.

Upon detection of the movement request for the specific device, the control unit 160 determines whether the waiting device list is full in step 343. Here, the control unit 160 may compare the number of devices currently on the waiting device list with the maximum number of devices allowed on the waiting device list.

When the waiting device list is full, the control unit 160 cancels the movement request in step 345 and performs a requested operation in step 347. For example, according to a user input or selection, the control unit 160 may return to step 311 and continue to provide services, may perform a procedure for disconnecting the specific device, or may release a Wi-Fi connection to a device on the waiting device list and delete the device from the waiting device list.

When the waiting device list is not full, the control unit 160 moves the specific device to the waiting device list in step 349, and applies packet filtering to the device using the MAC address of the specific device in step 351. As described before, the control unit 160 applies packet filtering to a device on the waiting device list so as to prevent the device from receiving the tethering service while providing the tethering service to a device on the operating device list. That is, a device on the waiting device list is allowed to connect to the WLAN terminal 100 through a Wi-Fi connection but is prevented from receiving the tethering service.

Next, device movement from the waiting device list to the operating device list is described with reference to steps 361 to 371 of FIG. 4.

Referring to FIGS. 3 and 4, while applying packet filtering to one or more devices on the operating device list, the control unit 160 may detect a request for moving a selected device on the waiting device list to the operating device list from the user in step 361. For example, the user of the WLAN terminal 100 supporting the mobile infrastructure mode may enter a request for moving a specific device from the waiting device list to the operating device list through the display unit 130 or the input unit 150. The display unit 130 or the input unit 150 transfers the movement request to the control unit 160.

Upon detection of the movement request, the control unit 160 determines whether the operating device list is full in step 363. Here, the control unit 160 may compare the number of devices currently on the operating device list with the maximum number of devices allowed on the operating device list.

When the operating device list is full, the control unit 160 cancels the movement request in step 365 and performs a requested operation in step 367. For example, the control unit 160 may continue to apply packet filtering to the specific device.

When the operating device list is not full, the control unit 160 moves the specific device from the waiting device list to the operating device list in step 369 and provides a requested service to the moved device in step 371. For example, in addition to an existing device already on the operating device list, the control unit 160 may allow the moved device to conduct data transmission and reception and provide a requested service such as the tethering service.

FIGS. 5 and 6 illustrate operations to manage external devices attempting to connect to the WLAN terminal for tethering according to an exemplary embodiment of the present invention.

FIGS. 5 and 6 illustrate example interface screens of the WLAN terminal supporting the mobile infrastructure mode in order to provide the tethering service to external devices. The interface screen of FIG. 5 represents the operating device list and the waiting device list in a graphic view mode. The interface screen of FIG. 6 represents the operating device list and the waiting device list in list view mode.

Referring to FIG. 5, in graphic view mode, the interface screen includes an operating region 530 and a waiting region 550. An AP item 510 associated with the WLAN terminal 100 is displayed at the center of the operating region 530 to represent relations between the AP item 510 and external devices. Devices in the operating region 530 correspond to devices on the operating device list, and devices in the waiting region 550 correspond to devices on the waiting device list. The interface screen may further include a setting menu item 570 for settings related to the operating device list and the waiting device list, and indicator items 590 providing a key or legend for the graphic view mode showing the operating and waiting regions 530 and 550. In the graphic view mode, due to the operating region 530 and a waiting region 550 being graphically displayed, the user may intuitively distinguish external devices that are on the operating device list from external devices that are on the waiting device list.

The user may move a device that is on the operating device list to the waiting device list when the waiting device list is not full, and move a device that is on the waiting device list to the operating device list when the operating device list is not full. Next, device movement between the lists while the WLAN terminal 100 is in a graphic view mode is described. In the present exemplary embodiment, it is assumed that the operating device list and the waiting device list may have up to four entries and currently have three entries.

As shown in FIG. 5, in the graphic view mode, the interface screen includes the operating region 530 corresponding to the operating device list and the waiting region 550 corresponding to the waiting device list. The operating region 530 and the waiting region 550 are represented by concentric circles with the AP item 510 at the center. A device may be moved between the operating region 530 and the waiting region 550 through simple interaction like a drag-and-drop gesture.

For example, when the user makes the drag-and-drop gesture to move a device 535 in the operating region 530 to the waiting region 550, the control unit 160 moves the device 535 from the operating region 530 to the waiting region 550. Here, the control unit 160 determines whether the waiting device list is full, and when the waiting device list is not full, removes the device 535 from the operating device list and adds the device 535 to the waiting device list.

When the user makes the drag-and-drop gesture to move a device 555 in the waiting region 550 to the operating region 530, the control unit 160 moves the device 555 from the waiting region 550 to the operating region 530. Here, the control unit 160 determines whether the operating device list is full, and when the operating device list is not full, removes the device 555 from the waiting device list and adds the device 555 to the operating device list.

Referring to FIG. 6, in a list view mode of the WLAN terminal 100, the interface screen includes an operating region 630 and a waiting region 650. Devices listed in the operating region 630 are on the operating device list, and devices listed in the waiting region 650 are on the waiting device list. The interface screen may further include a setting menu item 670 for settings related to the operating device list and the waiting device list. In the list view mode, thanks to the operating region 630 and the waiting region 650, the user may intuitively distinguish external devices that are on the operating device list and which are receiving the tethering service from external devices that are on the waiting device list and which are waiting for the tethering service.

The user may move a device that is on the operating device list to the waiting device list when the waiting device list is not full, and may move a device that is on the waiting device list to the operating device list when the operating device list is not full. Next, device movement between the lists in the list view mode is described. In the current exemplary embodiment, it is assumed that the operating device list and the waiting device list may each have up to four entries, and, as shown in FIG. 6, according to the present exemplary embodiment, currently have three entries and two entries, respectively.

As shown in FIG. 6, in the list view mode, the interface screen includes the operating region 630 corresponding to the operating device list and the waiting region 650 corresponding to the waiting device list. A device may be moved between the operating region 630 and the waiting region 650 through a simple interaction like the drag-and-drop gesture or a key input.

For example, when the user makes the drag-and-drop gesture to move a device 635, which is currently in the operating region 630, to the waiting region 650, the control unit 160 moves the device 635 from the operating region 630 to the waiting region 650. Here, the control unit 160 determines whether the waiting device list is full, and when the waiting device list is not full, removes the device 635 from the operating device list and adds the device 635 to the waiting device list.

When the user makes the drag-and-drop gesture to move a device 655, which is currently in the waiting region 650, to the operating region 630, the control unit 160 moves the device 655 from the waiting region 650 to the operating region 630. Here, the control unit 160 determines whether the operating device list is full, and when the operating device list is not full, removes the device 655 from the waiting device list and adds the device 655 to the operating device list.

Although not shown in FIG. 5 or 6, during the device movement, a first device on the operating device list may be exchanged with a second device on the waiting device list. For example, referring to FIG. 5, when the user makes the drag-and-drop gesture that encompasses a first device 535 in the operating region 530 and a second device 555 in the waiting region 550, the control unit 160 moves the first device 535 to the waiting region 550 and moves the second device 555 to the operating region 530. Here, the control unit 160 may replace the first device 535 with the second device 555 in the operating device list and may replace the second device 555 with the first device 535 in the waiting device list.

Although not shown in FIG. 5 or 6, the interface screen may support a removal of a device from the operating device list or the waiting device list. For example, referring to FIG. 6, when the user activates a “delete” function using the setting menu item 670 and makes a gesture to select a device in the operating region 630 or the waiting region 650, the control unit 160 deletes the selected device from the operating region 630 or the waiting region 650. Here, the control unit 160 removes the selected device from the operating device list or the waiting device list.

The tethering service method may be implemented as computer programs and may be stored in various computer readable storage media. The computer readable storage media may store program instructions, data files, data structures and combinations thereof. The program instructions may include instructions developed specifically for the present invention and existing general-purpose instructions.

The computer readable storage media may include magnetic media such as a hard disk and floppy disk, optical media such as a Compact Disk-Read Only Memory (CD-ROM) and a Digital Versatile Disk (DVD), magneto-optical media such as a floptical disk, and memory devices such as a Read Only Memory (ROM) and a Random Access Memory (RAM). The program instructions may include machine codes produced by compilers and high-level language codes executable through interpreters.

The description of the various embodiments is to be construed as exemplary only and does not describe every possible instance of the invention. Therefore, it should be understood that various changes may be made and equivalents may be substituted for elements of the invention.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of providing a tethering service, the method comprising:
receiving a connection request from an external device;
determining whether an operating device list is full;
adding the external device to the operating device list when the operating device list is not full;
providing a tethering service to the external device;
determining whether a waiting device list is full when the operating device list is full;
adding the external device to the waiting device list when the waiting device list is not full;
permitting connection of the external device and preventing the external device from receiving a tethering service; and
rejecting the connection request from the external device when the waiting device list is full.

2. The method of claim 1, wherein the determining of whether the operating device list is full comprises:
comparing a number of devices currently on the operating device list with a preset maximum number of devices allowed on the operating device list;
determining that the operating device list is not full when the number of devices currently on the operating device list is less than the maximum number of devices allowed on the operating device list; and
determining that the operating device list is full when the number of devices currently on the operating device list is equal to the maximum number of devices allowed on the operating device list.

3. The method of claim 2, wherein the adding of the external device to the operating device list comprises checking a Media Access Control (MAC) address of the external device when the operating device list is not full.

4. The method of claim 3, wherein the checking of the MAC address of the external device comprises determining whether the external device is a disconnected device by comparing the MAC address with each MAC address on a disconnection list.

5. The method of claim 4, further comprising:
adding the external device to the operating device list when the external device is not the disconnected device; and
determining whether the waiting device list is full when the external device is the disconnected device.

6. The method of claim 2, wherein the determining of whether the waiting device list is full comprises:
comparing a number of devices currently on the waiting device list with a preset maximum number of devices allowed on the waiting device list;
determining that the waiting device list is not full when the number of devices currently on the waiting device list is less than the maximum number of devices allowed on the waiting device list; and
determining that the waiting device list is full when the number of devices currently on the waiting device list is equal to the maximum number of devices allowed on the waiting device list.

7. The method of claim 6, wherein the adding of the external device to the waiting device list comprises permitting the device on the waiting device list to set up a Wireless-Fidelity (Wi-Fi) connection and rejecting a tethering request from the device by applying packet filtering to the device using a Media Access Control (MAC) address of the device.

8. The method of claim 2, further comprising:
detecting a disconnection request for a selected device on the operating device list or the waiting device list; and
adding the selected device to the disconnection list and releasing a connection with the selected device upon detection of the disconnection request for the selected device.

9. The method of claim 2, further comprising:
detecting an interaction for requesting movement of a selected device from the operating device list to the waiting device list; and
determining whether the waiting device list is full upon detection of the interaction for requesting a device movement.

10. The method of claim 9, further comprising:
cancelling the device movement request when the waiting device list is full; and
moving the selected device to the waiting device list when the waiting device list is not full; and
applying packet filtering to the selected device using a Media Access Control (MAC) address of the selected device in order to prevent the selected device from receiving a tethering service.

11. The method of claim 10, wherein the cancelling of the device movement request comprises:
providing a user with cancellation options including removing the selected device from the operating list.

12. The method of claim 2, further comprising:
detecting an interaction requesting movement of a selected device from the waiting device list to the operating device list; and
determining whether the operating device list is full upon detection of an interaction for requesting a device movement.

13. The method of claim 12, further comprising:
cancelling the device movement when the operating device list is full; and
moving the selected device to the operating device list and providing a tethering service to the selected device when the operating device list is not full.

14. The method of claim 13, wherein the cancelling of the device movement comprises:
providing a user with cancellation options including removing the selected device from the waiting list.

15. A Wireless Local Area Network (WLAN) terminal supporting a tethering service, the WLAN terminal comprising:
a WLAN module for performing data transmission and reception to and from an external device through a Wireless-Fidelity (Wi-Fi) connection;
a communication module for performing data transmission and reception for the WLAN terminal and the external device connected with the WLAN module;
a display unit for displaying an operating device list and a waiting device list in list view mode; and
a control unit for checking the operating device list and the waiting device list upon reception of a connection request from an external device, and for controlling an operation to support tethering when the external device is added to the operating device list in order to allow connection setup when the external device is added to the waiting device list, or to reject the connection request.

16. The WLAN terminal of claim 15, wherein the display unit displays an interface screen, the interface screen comprising:
an operating region corresponding to the operating device list; and
a waiting region corresponding to the waiting device list,
wherein the operating region and the waiting region are displayed in a graphic view mode or a list view mode.

17. The WLAN terminal of claim 16, wherein the control unit controls movement of a device between the operating region and the waiting region in the list view mode, and adds and deletes the device to and from the operating device list and the waiting device list according to the device movement.

18. The WLAN terminal of claim 16, wherein the control unit determines, upon detection of an interaction to move a selected device from the operating region to the waiting region, whether the waiting device list is full, and
wherein the control unit moves, when the waiting device list is not full, the selected device from the operating device list to the waiting device list and displays the selected device in the waiting region on the display unit.

19. The WLAN terminal of claim 16, wherein the control unit determines, upon detection of an interaction to move a selected device from the waiting region to the operating region, whether the operating device list is full, and moves, when the operating device list is not full, the selected device from the waiting device list to the operating device list and displays the selected device in the operating region on the display unit.
